(19) United States
(12) Patent Application Publication
(10) Pub. No.: US 2025/0265467 A1
(43) Pub. Date: Aug. 21, 2025

(54) TECHNIQUES FOR COMPRESSING ARTIFICIAL NEURAL NETWORKS

(71) Applicant: NVIDIA CORPORATION, Santa Clara, CA (US)

(72) Inventors: Ilia MARKOV, Vienna (AT); Hongxu YIN, San Jose, CA (US); Gregory HEINRICH, Nice (FR); Saurav MURALIDHARAN, San Jose, CA (US); Chenhan YU, Mountain House, CA (US); Jan KAUTZ, Lexington, MA (US); Pavlo MOLCHANOV, Mountain View, CA (US)

(21) Appl. No.: 19/002,459

(22) Filed: Dec. 26, 2024

Related U.S. Application Data
(60) Provisional application No. 63/554,538, filed on Feb. 16, 2024.

(51) Int. Cl. G06N 3/082; G06N 3/0495

(52) U.S. Cl. CPC G06N 3/082; G06N 3/0495

(57) ABSTRACT

At least one of the various embodiments is directed towards a computer-implemented method for generating trained artificial neural networks. The method includes, for each model layer included in a trained model, training one or more student model layers to mimic the model layer, for a first target device included in a plurality of target devices, generating one or more candidate architectures based on a constrained optimization problem and the one or more trained student model layers, training the one or more candidate architectures on a set of calibration data, selecting a first candidate architecture included in the one or more candidate architectures that is associated with a least amount of error, and performing a plurality of fine-turning training operations on the first candidate architecture to generate a first trained student model.

### CROSS-REFERENCE TO RELATED APPLICATIONS

This application claims benefit of the U.S. Provisional Patent Application titled, “UNIVERSAL MODEL COMPRESSION FOR TRANSFORMERS,” filed on Feb. 16, 2024, and having Ser. No. 63/554,538. The subject matter of this related application is hereby incorporated herein by reference.

### BACKGROUND OF THE INVENTION

### Field of the Invention

Embodiments of the present disclosure relate generally to large language model compression and, more specifically, to techniques for compressing artificial neural networks.

### Description of the Related Art

A large language model (LLM) is a type of artificial neural network (ANN) that has shown remarkable performance on a wide range of natural language processing (NLP) tasks, including text generation and classification. However, as LLMs grow in size and complexity, the computational and memory costs and latencies associated with training and deploying LLMs for various end-user applications also increase. These increasing costs and latencies can limit the overall effectiveness and usefulness of LLMs. Accordingly, various techniques have been developed to facilitate the training and deployment of LLMs.

One approach for increasing the overall effectiveness of LLMs involves constructing a family of smaller LLMs instead of a single large LLM, where each smaller LLM is tailored to execute on specified hardware and within specified time constraints. Neural architecture search (NAS) is a technique that is commonly used to construct groups of smaller LLMs subject to various model size, hardware, and memory constraints. An NAS algorithm is classified according to the three phases used to construct the model architecture: the search space, the search strategy, and the performance estimation strategy. The search space defines the set of architectures that can be used to represent the various smaller LLMs, including number of layers, type of layers (e.g., multilayer perceptron, convolution, attention etc.), and the number of parameters per layer (e.g., number of neurons). The search strategy is used to explore the search space, select a given architecture based on a variety of factors, and build the smaller LLMs based on the selected architecture. The performance estimation strategy estimates how well the model architecture found in the search phase performs on new data. A common performance estimation strategy is to train the model found in the search phase on a training dataset and evaluate the performance on a validation dataset.

One drawback of using NAS to develop groups of smaller LLMs is the amount of time the NAS algorithm needs to explore the search space and select an architecture to use for smaller LLMs, especially when the search space is large. Shrinking the search space can speed up execution, but, if the search space is too small, then the NAS algorithm is more unlikely to find an optimized architecture to use for the smaller LLMs. Another drawback of NAS is that the performance estimation strategy usually requires each smaller LLM to be trained from scratch and then evaluated. Training numerous LLMs, even smaller ones, from scratch can take quite a bit of time and consume large amounts of computing resource, which can make NAS impractical for many applications.

Another approach to increasing the overall effectiveness of LLMs involves model compression, where a pre-trained LLM is compressed to generate a smaller LLM. Three common model compression techniques are pruning, quantization, and knowledge distillation. Pruning is the process of removing redundant parameters, such as neurons, from an existing model. Redundant parameters are typically considered to be parameters whose removal from a model minimally affects the output of the model. Pruning can be unstructured, where individual parameters are removed from a model regardless of where those parameters reside within the model, or structured, where groups of parameters are removed from certain locations within a model. Quantization is where the different weights within a model are represented using a reduced number of bits. Using fewer bits for the weights reduces the amount of memory resources consumed by the model and also reduces computational complexity of the operations performed using the model. Knowledge distillation uses a larger, pre-trained “teacher” model to train a smaller, “student” model, where, during training, the knowledge of the teacher model is transferred to the student model.

One drawback of model compression is the tradeoff between the increase in model efficiency and the loss of model accuracy. While the above model compression techniques result in smaller models that can execute faster, large amounts of compression can result in substantial execution inaccuracies due to the amounts of information removed from the models. In addition, model compression oftentimes requires the hyperparameters of a model to be manually tuned, which is a process that can be tedious, time consuming, and prone to error.

As the foregoing illustrates, what is needed in the art are more effective techniques for compressing LLMs and other artificial neural networks.

### SUMMARY

At least one of the various embodiments is directed towards a computer-implemented method for generating trained artificial neural networks. The method includes, for each model layer included in a trained model, training one or more student model layers to mimic the model layer, for a first target device included in a plurality of target devices, generating one or more candidate architectures based on a constrained optimization problem and the one or more trained student model layers, training the one or more candidate architectures on a set of calibration data, selecting a first candidate architecture included in the one or more candidate architectures that is associated with a least amount of error, and performing a plurality of fine-tuning training operations on the first candidate architecture to generate a first trained student model.

At least one technical advantage of the disclosed techniques relative to the prior art is that the disclosed techniques can substantially facilitate the training and deployment of LLMs across multiple different hardware implementations. In this regard, the disclosed techniques can be used to generate a different trained student LLM for each different hardware implementation based on a single trained LLM. Thus, with the disclosed techniques, multiple different smaller trained student LLMs can be generated for multiple different hardware implementations without having to train each student LLM from scratch, thereby reducing the time and compute resources needed to deploy new trained models. In addition, the student LLMs generated using the disclosed techniques can improve the latency and memory footprint of the original trained LLM without any substantial losses in accuracy. The disclosed techniques also implement constrained optimization problems to automate the design the different student LLM architectures, thereby eliminating the need for manual hyperparameter fine tuning. These technical advantages provide one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computer-based system configured to implement one or more aspects of the various embodiments;

FIG. 2 is a more detailed illustration of the architecture of trained LLM of FIG. 1, according to various embodiments;

FIG. 3 is a block diagram of a LLM architecture optimizer of FIG. 1, according to various embodiments;

FIG. 4 is a more detailed illustration of candidate architecture generator of FIG. 3, according to various embodiments;

FIG. 5 is a more detailed illustration of student architecture selector of FIG. 3, according to various embodiments;

FIG. 6 is a flow diagram of method steps for generating candidate architectures, according to various embodiments; and

FIG. 7 is a flow diagram of method steps for generating student LLMs, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

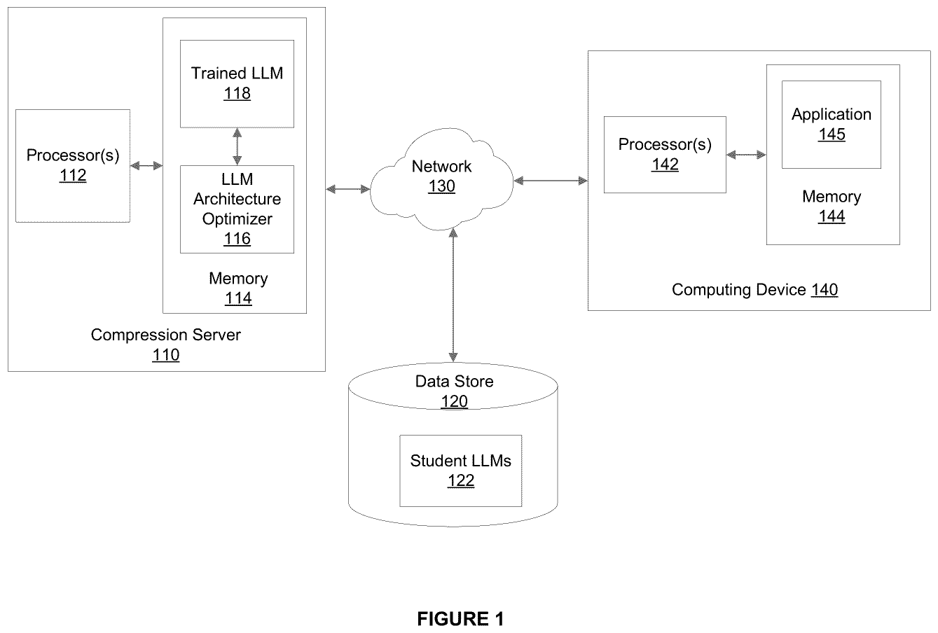

FIG. 1 illustrates a block diagram of a computer-based system 100 configured to implement one or more aspects of the various embodiments. As shown, system 100 includes, without limitation, a compression server 110, a data store 120, a network 130, and a computing device 140. Compression server 110 includes, without limitation, processor(s) 112 and a system memory 114. System memory 114 includes, without limitation, an LLM architecture optimizer 116 and a trained LLM 118. Computing device 140 includes, without limitation, processor(s) 142 and memory 144. Memory 144 includes, without limitation, an application 145. Data store 120 includes, without limitation, a student LLM 122.

Compression server 110 shown herein is for illustrative purposes only, and variations and modifications are possible without departing from the scope of the present disclosure. For example, the number and types of processors 112, the number of GPUs and/or other processing unit types, the number and types of system memories 114, and/or the number of applications included in the system memory 114 can be modified as desired. Further, the connection topology between the various units in FIG. 1 can be modified as desired. In some embodiments, any combination of the processor(s) 112 and the system memory 114, and/or GPU(s) can be included in and/or replaced with any type of virtual computing system, distributed computing system, and/or cloud computing environment, such as a public, private, or a hybrid cloud system.

Processor(s) 112 receive user input from input devices, such as a keyboard or a mouse. Processor(s) 112 can be any technically feasible form of processing device configured to process data and execute program code. For example, any of processor(s) 112 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 112, or any combination of these different processors, such as a CPU working in cooperation with one or more GPUs. In various embodiments, the one or more GPU(s) perform parallel processing task, such as matrix multiplications and/or the like in LLM model computations. Processor(s) 112 can also receive user input from input devices, such as a keyboard or a mouse and generate output on one or more displays.

System memory 114 of compression server 110 stores content, such as software applications and data, for use by processor(s) 112. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 114. The storage can include any number and type of external memories that are accessible to processor(s) 112. For example, and without limitation, the storage can include a Secure Digital Card, an external Flash memory, a portable compact disc read-only memory (CD-ROM), an optical storage device, a magnetic storage device, and/or any suitable combination of the foregoing.

LLM architecture optimizer 116 stored within system memory 114 is configured to generate student LLMs 122 by compressing and optimizing the architecture of trained LLM 118. More specifically, LLM architecture optimizer 116 generates student LLMs 122 by replacing the layers of trained LLM 118 with different compressed or optimized layers based on various target constraints, such as hardware and memory constraints or latency and numbers of parameters. LLM architecture optimizer 116 then stores student LLMs 122 in data store 120. Student LLMs 122 can then be used in any suitable application, such as application 145 executing on computing device 140, for inferencing operations.

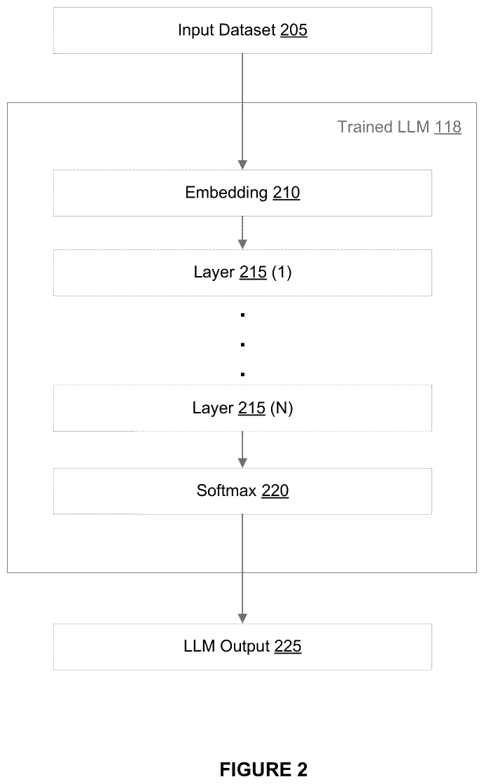

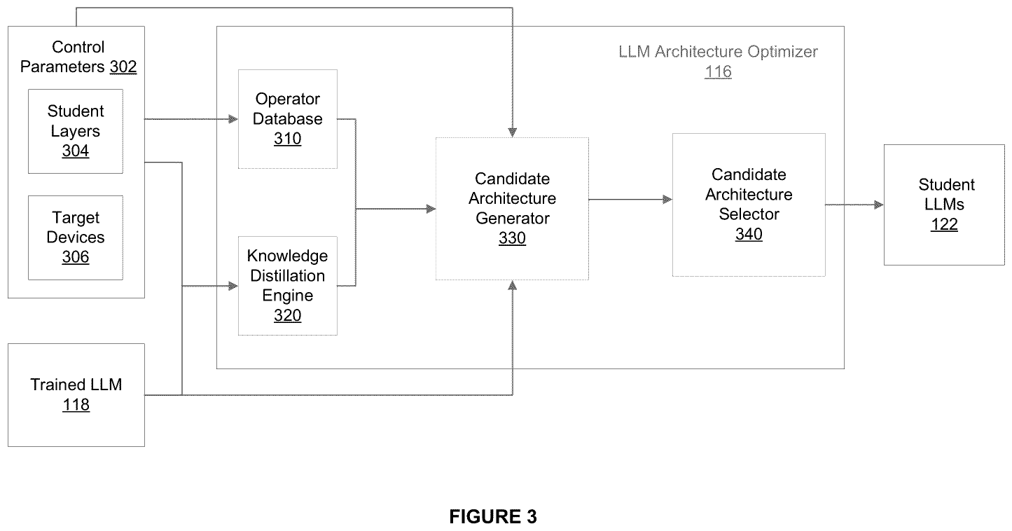

Trained LLM 118 can be any type of technically feasible machine learning model. For example, in various embodiments, trained LLM 118 can be a transformer based LLM model, such as a generative pre-trained transformer (GPT), with any suitable architecture. Similarly, student LLMs 122 can be any type of technically feasible machine learning models. For example, in various embodiments, student LLMs 122 can be transformer based LLMs, such as a GPT, with any suitable architecture. The architecture of trained LLM 118 is described in greater detail below in conjunction with FIG. 2. The operations performed by LLM architecture optimizer 116 to generate student LLMs 122 by compressing and optimizing trained LLM 118 are described in greater detail below in conjunction with FIGS. 3-7.

Data store 120 provides non-volatile storage for applications and data in compression server 110 and computing device 140. For example, and without limitation, training data, trained (or deployed) machine learning models and/or application data, including trained LLM 118, and student LLM 122 can be stored in the data store 120. In some embodiments, data store 120 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 120 can be a network attached storage (NAS) and/or a storage area-network (SAN). Although shown as coupled to compression server 110 and computing device 140 via network 130, in various embodiments, compression server 110 or computing device 140 can include data store 120.

Network 130 includes any technically feasible type of communications network that allows data to be exchanged between compression server 110, computing device 140, data store 120 and external entities or devices, such as a web server or another networked computing device. For example, network 130 can include a wide area network (WAN), a local area network (LAN), a cellular network, a wireless (WiFi) network, and/or the Internet, among others.

Computing device 140 shown herein is for illustrative purposes only, and variations and modifications are possible without departing from the scope of the present disclosure. For example, the number and types of processors 142, the number and types of system memories 144, and/or the number of applications included in the system memory 144 can be modified as desired. Further, the connection topology between the various units in FIG. 1 can be modified as desired. In some embodiments, any combination of the processor(s) 142 and/or the system memory 144 can be included in and/or replaced with any type of virtual computing system, distributed computing system, and/or cloud computing environment, such as a public, private, or a hybrid cloud system.

Processor(s) 142 receive user input from input devices, such as a keyboard or a mouse. Processor(s) 142 can be any technically feasible form of processing device configured to process data and execute program code. For example, any of processor(s) 142 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 142, or any combination of these different processors, such as a CPU working in cooperation with a one or more GPUs. In various embodiments, the one or more GPU(s) perform parallel processing task, such as matrix multiplications and/or the like in LLM model computations. Processor(s) 142 can also receive user input from input devices, such as a keyboard or a mouse and generate output on one or more displays.

Similar to memory 114 of compression server 110, memory 144 of computing device 140 stores content, such as software applications and data, for use by the processor(s) 142. The system memory 144 can be any type of memory capable of storing data and software applications, such as a RAM, ROM, EPROM, Flash ROM, or any suitable combination of the foregoing. In some embodiments, a storage (not shown) can supplement or replace the system memory 144. The storage can include any number and type of external memories that are accessible to processor 142. For example, and without limitation, the storage can include a Secure Digital Card, an external Flash memory, a portable CD-ROM, an optical storage device, a magnetic storage device, and/or any suitable combination of the foregoing.

To perform inferencing operations, application 145 stored within memory 144 accesses student LLM 122 from data store 120. Application 145 then presents input data to student LLM 122 to generate output data.

FIG. 2 is a more detailed illustration of the architecture of trained LLM 118 of FIG. 1, according to various embodiments. As shown, trained LLM 118 includes, without limitation, embedding layer 210, multiple layers 215(1)-(N), and softmax layer 220. During execution, input dataset 205 is input into trained LLM 118, where embedding layer 210, layers 215(1)-(N), and softmax layer 220 then perform various operations to generate LLM output 225.

In various embodiments, trained LLM 118 comprises a transformer-based LLM that is configured to process input dataset 205. In various embodiments, input dataset 205 may be text data, such as words or sentences, or may be image or video data. More generally, input data set 205 can include any technically feasible data that can be processed by a transformer-based language model. Upon receiving input dataset 205, embedding layer 210 converts the elements of input dataset 205 to numeric representations, called tokens, and encodes each token as a vector. The vectors generated by embedding layer 210 subsequently pass through multiple layers 215(1)-(N). Each layer 215 may comprise an attention layer or multilayer perceptron (MLP) layer, with varying numbers of internal parameters including, without limitation, numbers of attention heads, key-value projection dimensions, numbers of neurons, or types of activation functions. In various embodiments, each layer 215 may comprise a layer norm layer, a linear layer, a convolutional layer, a pooling layer, or any other type of viable artificial neural network layer. Each layer 215 produces a vector or matrix as the result of applying weight matrices and an activation function to the vector or matrix output of the layer preceding it. Softmax layer 220 normalizes the output vector of layer 215 (N) to a probability distribution of predicted outcomes and generates LLM output 225. In some embodiments, where the objective of trained LLM 118 is question answering, next word/sentence prediction, word/sentence translation, or image generation, LLM output 225 may be the probability distribution of the next word/sentence that comes after the input word/sentence, the translation of the input word/sentence, the answer to the question input, or the images generated in response to image and text caption input.

### Generating Student Large Language Models

FIG. 3 is a more detailed illustration of the LLM architecture optimizer 116 of FIG. 1, according to various embodiments. As shown, LLM architecture optimizer 116 includes, without limitation, an operator database 310, a knowledge distillation engine 320, a candidate architecture generator 330, and a candidate architecture selector 340. In operation, LLM architecture optimizer 116 receives trained LLM 118 and control parameters 302 from a user via a user interface (not shown) and generates student LLMs 122. Control parameters 302 include, without limitation, student layers 304 and target devices 306. Student layers 304 sets forth a list of candidate layers for student LLMs 122. In various embodiments, student layers 304 may include a copy of each layer 215 of trained LLM 118, pruned versions of each layer 215 of trained LLM 118, quantized versions of each layer 215 of trained LLM 118, identity layers, attention layers, or MLP layers. Target devices 306 is a list of devices on which student LLMs 122 may be deployed. Target devices 306 can include, without limitation, a server machine, a desktop machine, a laptop computer, a mobile phone, or a GPU or other type of processor.

Operator database 310 receives as input student layers 304 and target devices 306 from control parameters 302. Operator database 310 subsequently generates a lookup table of performance metrics for each student layer 304 operating on any target device 306 and associated target deployment setup, such as the hardware characteristics of target device 306 and the usage regime associated with target device 306. The performance metrics included in the lookup table may include, without limitation, processing latency, processing throughput, and memory footprint. Processing latency typically measures the total time needed for each student layer 304 to generate an output based on a given input prompt. Processing latency may be measured in multiple phases, including the time needed for each student layer 304 to process the input tokens, called the prefill phase, and the time needed for each student layer 304 to generate output tokens, called the decode phase. Processing throughput typically measures the number of tokens each student layer 304 can process or generate in a certain amount of time. Memory footprint typically measures the amount of memory required to store the parameters of each student layer 304. The performance metrics included in the lookup table of operator database 310 can then be used by candidate architecture generator 330 to generate one or more constraint equations of a constrained optimization problem, as described below.

For a given layer 215 of trained LLM 118, knowledge distillation engine 320 receives one or more student layers 304 having the same input and output dimensions as the given layer 215 of trained LLM 118. Knowledge distillation engine 320 subsequently trains these one or more student layers 304 to mimic the given layer 215 of trained LLM 118. Knowledge distillation engine 320 can use any feasible training technique to train student layers 304, such as stochastic gradient descent with backpropagation, adaptive moment estimation (Adam), or root mean squared propagation (RMSprop). During training, knowledge distillation engine 320 first computes the layer-wise loss between the given layer 215 of trained LLM 118 and the one or more student lavers 304, called an operator score, according to equation (1):

$${min}_{W} {\sum }_{x ∈ X} ℒ ( {t}_{i} ( {x}_{i} ) , {s}_{i , j} ( {x}_{i} ; {w}_{i , j} ) ) \qquad ( 1 )$$

where X is a set of training samples, tᵢ is the operation of the given layer 215 of trained LLM 118, xᵢ is the input to the given layer 215 of trained LLM 118, {s_{i,j}} is the set of operations of the one or more student layers 304, W={w_{i,j}} is the set of weights corresponding to the set operations of the one or more student layers 304, and [symbol] is a loss function. Examples of suitable loss functions [symbol] include, without limitation, L₁ norm, mean squared error (MSE), and normalized MSE. Knowledge distillation engine 320 then updates the set of weights W of the one or more student layers 304 according to the training technique to mimic the operations of the given layer 215 of trained LLM 118. Knowledge distillation engine 320 repeats the process for each of the remaining layers 215 of trained LLM 118.

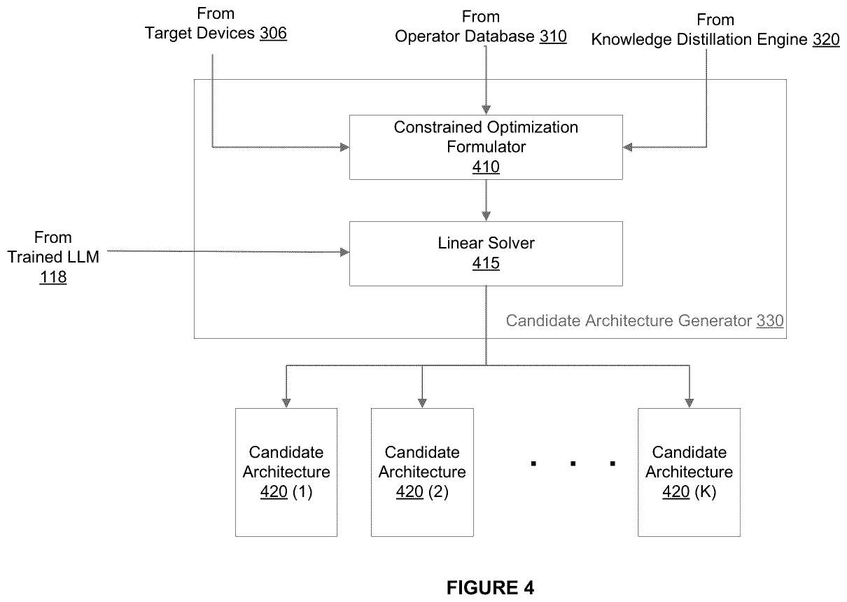

Candidate architecture generator 330 receives operator database 310, the operator scores and weights of the student layers 304 trained by knowledge distillation engine 320, trained LLM 118, and target devices 306 from control parameters 302. For a given device from target devices 306, candidate architecture generator 330 uses constrained optimization to determine a set of one or more candidate architectures for the student LLM 120. The operations of candidate architecture generator 330 are described in further detail below in conjunction with FIG. 4.

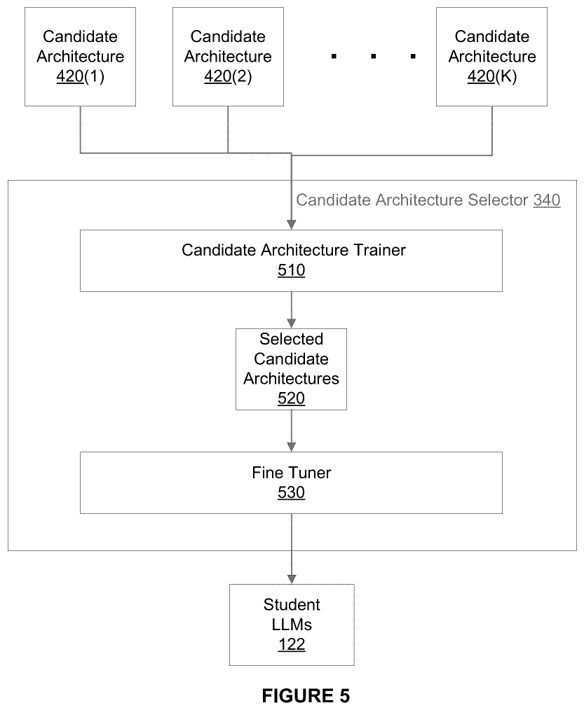

Candidate architecture selector 340 receives the different sets of candidate architectures generated by candidate architecture generator 330. Candidate architecture selector 340 subsequently trains each received candidate architecture on various calibration data. The calibration data may include, without limitation, the original training data used to train trained LLM 118, a subset of the original training data used to train trained LLM 118, or any other data not presented to trained LLM 118 during training. After training all the different sets of candidate architectures received from candidate architecture generator 330, candidate architecture selector 340 selects as the student LLM 122 the candidate architecture with the least error between the predicted outputs and the true outputs on the calibration dataset. The operations of candidate architecture selector 340 are described in further detail below in conjunction with FIG. 5.

FIG. 4 is a more detailed illustration of the candidate architecture generator 330 of FIG. 3, according to various embodiments. As shown, candidate architecture generator 330 includes, without limitation, constrained optimization formulator 410 and integer linear programming solver 415. As noted above, in operation, candidate architecture generator 330 receives operator database 310, the operator scores and weights of the student layers 304 trained by knowledge distillation engine 320, trained LLM 118, and target devices 306 from control parameters 302 and generates the different candidate architectures 420(1)-(K). More specifically, target devices 306, operator database 310, and the operator scores and weights of the student layers 304 trained by knowledge distillation engine 320 are input into constrained optimization formulator 410. Constrained optimization formulator 410 then sets up a constrained optimization problem to be solved by integer linear programming solver 415, where the constrained optimization problem includes, without limitation, an objective function to be minimized with respect to certain variables and one or more constraint equations that set conditions on those certain variables. In this regard, for a given target device 306, constrained optimization formulator 410 formulates the objective function included in the optimization problem as a loss function [symbol] that estimates the error between the output of a candidate architecture 420 and the true value on a given dataset. In various embodiments, the loss function [symbol] may be determined in accordance with equation (2):

$${\sum }_{( x , y ) ∈ X} ℒ ( 𝒞 ( x ; Z , W ) , y ) \qquad ( 2 )$$

where W is the set of weights of student layers 304 trained by knowledge distillation engine 320, Z={zᵢ} is a set of binary vectors such that z; is a one-hot vector representing the choice of student layer 304, [symbol] (x; Z, W) is the candidate architecture defined by Z and W, and X is dataset whose elements are the labelled pairs (x,y). Constrained optimization formulator 410 then uses the lookup table of operator database 310 to determine at least one constraint equation according to equation (3):

$$ℱ ( {\sum }_{i} {p}_{i}^{T} {z}_{i} , 𝒫 ) \geq 0 \qquad ( 3 )$$

where, [symbol] a function which defines the performance budget for a given target device 306, pᵢ is a vector whose components are the performance metrics for each student layer 304 corresponding to the given target device 306 included in the lookup table of operator database 310, and [symbol] is a user-defined constant.

Constrained optimization formulator 410 passes equations (2)-(3) to integer linear programming solver 415. In turn, integer linear programming solver 415 first approximates the loss function in equation (2) using a linear function according to equation (4):

$${\sum }_{( x , y ) ∈ X} ℒ ( 𝒞 ( x ; Z , W ) , y ) \approx {\sum }_{( x , y ) ∈ X} ℒ ( T ( x ) , y ) + {\sum }_{i} {e}_{i}^{T} {z}_{i} \qquad ( 4 )$$

where T(x)=t_{N}^{∘}t_{N-1}^{∘} . . . ^{∘}t₁(x) is the set of operations performed by trained LLM 118 in response to an input x, Σ_{(x,y)∈x} [symbol] (T(x),y) is a constant that represents the error between the output of trained LLM 118 and the true value y on the dataset X, and eᵢ is a vector where each component is the difference between the output of trained LLM 118 on a small labelled dataset and the output of trained LLM 118 on the same small labelled dataset when a given student layer 304 included in student layers 304 replaces one of the layers 215 of trained LLM 118, and all other layers 215 of trained LLM 118 are unchanged (repeated across all of the different student layers 304 to obtain all of the different components of vector eᵢ). Integer linear programming solver 415 then generates a candidate architecture 420 by solving the following integer linear minimization problem given by equations (5)-(6):

$${min}_{Z} {\sum }_{i} {e}_{i}^{T} {z}_{i} \qquad ( 5 )$$

$$ℱ ( {\sum }_{i} {p}_{i}^{T} {z}_{i} , 𝒫 ) \geq 0 \qquad ( 6 )$$

Integer linear programming solver 415 can use any feasible integer linear optimization technique to solve equations (5)-(6), such as a cutting plane algorithm or a branch and bound algorithm. Integer linear programming solver 415 generates a set of candidate architectures 420 by solving the following linear minimization problem given by equations (7)-(9):

$${min}_{{Z}^{( k )}} {\sum }_{i} {e}_{i}^{T} {z}_{i}^{( k )} \qquad ( 7 )$$

$$ℱ ( {\sum }_{i} {p}_{i}^{T} {z}_{i}^{( k )} , 𝒫 ) \geq 0 \qquad ( 8 )$$

$${\sum }_{i} {z}_{i}^{( k ) T} {z}_{i}^{( {k}^{′} )} \leq 𝒪 , for all {k}^{′} < k \qquad ( 9 )$$

where equation (9) acts as a constraint on the maximum overlap with any other solution to equations (7)-(8). After completing these operations, integer linear programming solver 415 passes candidate architectures 420 to candidate architecture selector 340.

FIG. 5 is a more detailed illustration of the candidate architecture selector 340 of FIG. 3, according to various embodiments. As shown, candidate architecture selector 340 includes, without limitation, candidate architecture trainer 510, selected candidate architectures 520, and fine tuner 530. In operation, candidate architecture selector 340 receives candidate architectures 420 from candidate architecture generator 330 and generates student LLMs 122. In this regard, different sets of candidate architectures 420 are first input into candidate architecture trainer 510, which trains the different sets of candidate architectures 420 on a calibration dataset. The calibration data may include, without limitation, the original training data used to train trained LLM 118, a subset of the original training data used to train trained LLM 118, or any other data not presented to trained LLM 118 during training. From each set of candidate architectures 420, candidate architecture trainer 510 subsequently selects the candidate architecture 420 with the least error between the predicted output and the true output on the calibration dataset as the selected candidate architecture 520. Each selected candidate architecture 520 is then input into fine tuner 530 to undergo further training. Fine tuner 530 trains each selected candidate architecture 520 on the same dataset used to train trained LLM 118 and uses the same learning rate schedule that was used when training trained LLM 118. The learning rate schedule is a technique that adjusts the learning rate between iterations during the training process. The technique implemented by learning rate schedule may include, without limitation, step decay, exponential decay, and cosine annealing. After training, fine tuner 530 outputs student LLMs 122.

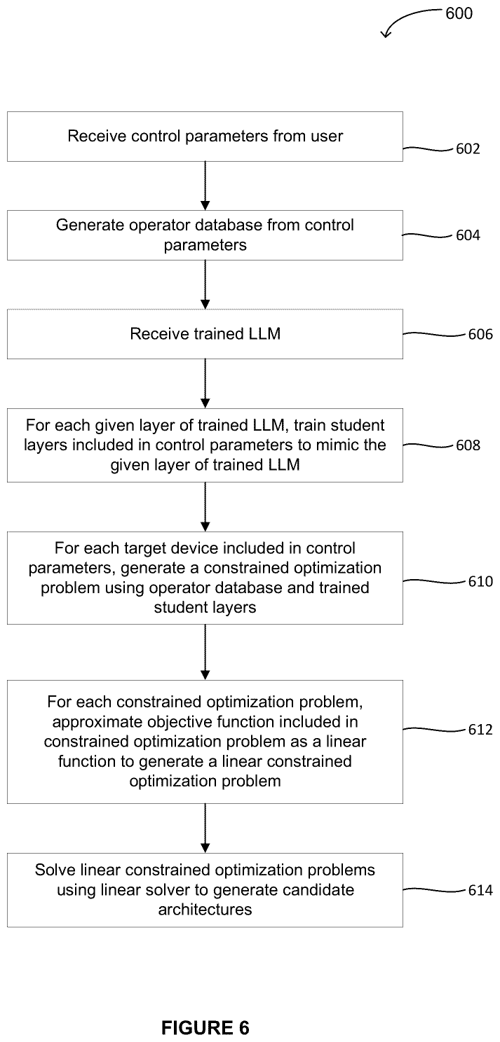

FIG. 6 is a flow diagram of method steps for generating candidate architectures, according to various embodiments. Although the method steps are described in conjunction with the systems of FIGS. 1-5, persons skilled in the art will understand that any system configured to perform the method steps, in any order, falls within the scope of the various embodiments.

As shown, a method 600 begins at step 602, where LLM architecture optimizer 116 receives control parameters 302 from a user via a user interface (not shown). Examples of different control parameters 302 that can be input by the user include, without limitation, student layers 304 and target devices 306.

At step 604, LLM architecture optimizer 116 generates an operator database from the received control parameters 302. More specifically, the control parameters 302 are input into operator database 310. Operator database 310 then generates a lookup table of performance metrics for each student layer 304 included in control parameters 302 operating on any target device 306 included in control parameters 302 in conjunction with an associated target deployment setup. Target deployment setups may include, without limitation, the hardware characteristics of target device 306 and the usage regime associated with target device 306. The performance metrics included in the lookup table may include, without limitation, processing latency, processing throughput, and memory footprint.

At step 606, LLM architecture optimizer 116 receives trained LLM model 118, which can be any type of machine learning model. For example, in various embodiments, trained LLM 118 can be a transformer based LLM, such as a GPT, with any suitable architecture. LLM architecture optimizer 116 can receive trained LLM 118 from any storage device, such as data store 120.

At step 608, for each given layer 215 of trained LLM 118, knowledge distillation engine 320 trains the student layers 304 included in the control parameters 302 to mimic the given layer 215 of trained LLM 118. Knowledge distillation engine 320 trains the different student layers 304 by computing the layer-wise loss between the given layer 215 of trained LLM 118 and the different student layers 304. Knowledge distillation engine 320 can use any loss function, such as L₁ norm, MSE, and normalized MSE, during these training operations. Similarly, knowledge distillation engine 320 can use any feasible training technique to train student layers 304, such as stochastic gradient descent with backpropagation, Adam, or RMSprop.

At step 610, for each target device 306 included in control parameters 302, constrained optimization formulator 410 generates a constrained optimization problem using operator database 310 and the trained student layers generated by knowledge distillation engine 320. The constrained optimization problem includes, without limitation, an objective function to be minimized with respect to certain variables and one or more constraint equations that set conditions on those certain variables. Constrained optimization formulator 410 uses the trained student layers generated by knowledge distillation engine 320 to generate the objective function of the constrained optimization problem and uses the performance metrics included in the lookup table of operator database 310 to generate the one or more constraint equations of the constrained optimization problem.

At step 612, for each constrained optimization problem generated by constrained optimization formulator 410, integer linear programming solver 415 approximates the objective function included in the constrained optimization problem as a linear function to generate a linear constrained optimization problem.

At step 614, integer linear programming solver 415 solves the different linear constrained optimization problems to generate candidate architectures 420. Integer linear programming solver 415 can use any feasible integer linear optimization technique to solve the linear constrained optimization problems, such as a cutting plane algorithm or a branch and bound algorithm.

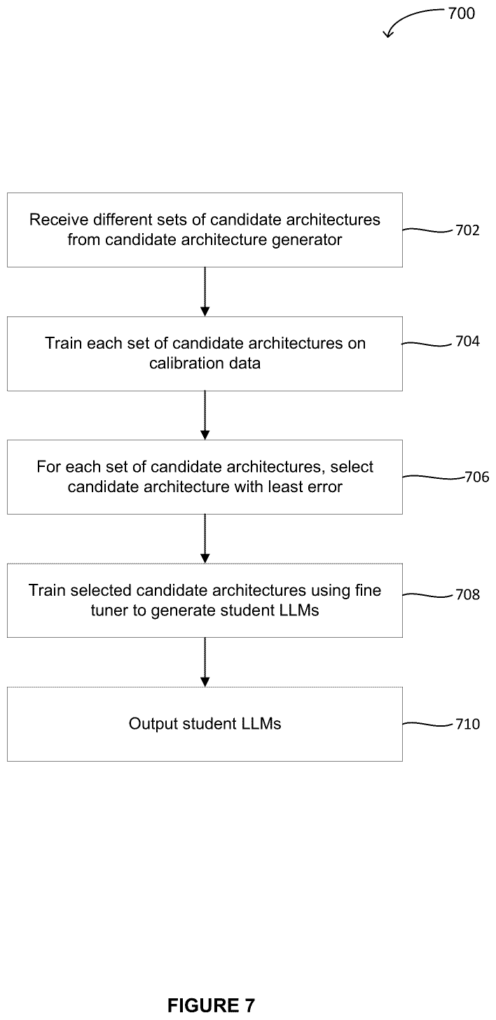

FIG. 7 is a flow diagram of method steps for generating student LLMs, according to various embodiments. Although the method steps are described in conjunction with the systems of FIGS. 1-5, persons skilled in the art will understand that any system configured to perform the method steps, in any order, falls within the scope of the various embodiments.

As shown, a method 700 begins at step 702, where candidate architecture selector 340 receives different sets of candidate architectures 420 from candidate architecture generator 330.

At step 704, candidate architecture selector 340 trains each set of candidate architectures 420 on calibration data. Calibration data may include, without limitation, the original training data used to train trained LLM 118, a subset of the original training data used to train trained LLM 118, or any other data not presented to trained LLM 118 during training.

At step 706, for each set of candidate architectures 420, candidate architecture trainer 510 selects the candidate architecture with least error as a selected candidate architecture 520. As previously described herein, in various embodiments, candidate architecture trainer 510 selects the candidate architecture 420 with the least error between the predicted output and the true output on the calibration dataset as the selected candidate architecture 520.

At step 708, fine tuner 530 trains the selected candidate architectures 520 to generate student LLMs 122. Fine tuner 530 trains each selected candidate architecture 520 on the same dataset used to train trained LLM 118 and uses the same learning rate schedule that was used when training trained LLM 118. Fine tuner can use any feasible learning rate schedule, such as step decay, exponential decay, and cosine annealing during this fine-tuning phase. At step 710, candidate architecture selector 340 outputs student LLMs 122.

In sum, the architecture of a trained LLM is optimized for execution on specified hardware and compressed based on target constraints, such as latency and number of parameters, to construct a smaller “student” LLM. First, a database of potential layer types, called student layers, for the student LLM is constructed. Next, an operator score is computed for each student layer of the student LLM based on how well that student layer mimics the corresponding layer in the original, trained LLM. The operator scores and hardware-specific latency and memory constraints are used to construct a set of candidate architectures for the student LLM. Each candidate architecture is then trained on a calibration dataset, and the architecture with minimal loss of accuracy, when executed, is selected for deployment and subsequently fine-tuned. The result is a smaller LLM that has improved execution latencies and a reduced memory footprint with a minimized loss of accuracy relative to the original, trained LLM.

At least one technical advantage of the disclosed techniques relative to the prior art is that the disclosed techniques can substantially facilitate the training and deployment of LLMs across multiple different hardware implementations. In this regard, the disclosed techniques can be used to generate a different trained student LLM for each different hardware implementation based on a single trained LLM. Thus, with the disclosed techniques, multiple different smaller trained student LLMs can be generated for multiple different hardware implementations without having to train each student LLM from scratch, thereby reducing the time and compute resources needed to deploy new trained models. In addition, the student LLMs generated using the disclosed techniques can improve the latency and memory footprint of the original trained LLM without any substantial losses in accuracy. The disclosed techniques also implement constrained optimization problems to automate the design the different student LLM architectures, thereby eliminating the need for manual hyperparameter fine tuning. These technical advantages provide one or more technological improvements over prior art approaches.

1. Some embodiments are directed towards a computer-implemented method for generating trained artificial neural networks, where the method comprises: for each model layer included in a trained model, training one or more student model layers to mimic the model layer; for a first target device included in a plurality of target devices, generating one or more candidate architectures based on a constrained optimization problem and the one or more trained student model layers; training the one or more candidate architectures on a set of calibration data; selecting a first candidate architecture included in the one or more candidate architectures that is associated with a least amount of error; and performing a plurality of fine-turning training operations on the first candidate architecture to generate a first trained student model.

2. The computer-implemented method of clause 1, wherein generating the one or more candidate architectures comprises generating a linear constrained optimization problem based on an objective function included in the constrained optimization problem, and computing a solution to the linear constrained optimization problem to generate at least one of the one to more candidate architectures.

3. The computer-implemented method of either clause 1 or 2, wherein the linear constrained optimization problem includes a linear function that comprises an approximation of the objective function included in the constrained optimization problem.

4. The computer-implemented method of any of clauses 1-3, wherein the one or more student model layers and the plurality of target devices comprise user-defined control parameters.

5. The computer-implemented method of any of clauses 1-4, wherein the first candidate architecture has less error between a predicted output and a true output generated using the set of calibration data than any other candidate architecture included in the one or more candidate architectures.

6. The computer-implemented method of any of clauses 1-5, wherein performing the plurality of fine-tuning operations on the first candidate architecture comprises training the first candidate architecture on a dataset used to train the trained model.

7. The computer-implemented method of any of clauses 1-6, wherein a learning rate schedule used when training the trained model is implemented when performing the plurality of fine-tuning operations on the first candidate architecture.

8. The computer-implemented method of any of clauses 1-7, wherein the one or more student layers include a copy of each layer included in the trained model, a pruned version of each layer included in the trained model, at least one identity layer, at least one attention layer, or at least one multilayer perceptron layer.

9. The computer-implemented method of any of clause 1-8, wherein the one or more student model layers and the model layer have the same input dimensions and the same output dimensions.

10. The computer-implemented method of any of clause 1-9, wherein the first trained student model has less execution latency relative to an execution latency associated with the trained model.

11. Some other embodiments are directed towards one or more non-transitory computer-readable media including instructions that, when executed by one or more processors, cause the one or more processors to perform the steps of: for each model layer included in a trained model, training one or more student model layers to mimic the model layer; for a first target device included in a plurality of target devices, generating one or more candidate architectures based on a constrained optimization problem and the one or more trained student model layers; training the one or more candidate architectures on a set of calibration data; selecting a first candidate architecture included in the one or more candidate architectures that is associated with a least amount of error; and performing a plurality of fine-turning training operations on the first candidate architecture to generate a first trained student model.

12. The one or more non-transitory computer-readable media of clause 11, wherein the plurality of target devices include at least one of a server machine, a desktop machine, a graphics processing unit, a laptop computer, or a mobile phone.

13. The one or more non-transitory computer-readable media of either clause 11 or 12, wherein the first trained student model has a memory footprint that is smaller than a memory footprint associated with the trained model.

14. The one or more non-transitory computer-readable media of any of clauses 11-13, wherein generating the one or more candidate architectures comprises generating a linear constrained optimization problem based on an objective function included in the constrained optimization problem, and computing a solution to the linear constrained optimization problem to generate at least one of the one to more candidate architectures.

15. The one or more non-transitory computer-readable media of any of clauses 11-14, wherein the linear constrained optimization problem includes a linear function that comprises an approximation of the objective function included in the constrained optimization problem.

16. The one or more non-transitory computer-readable media of any of clauses 11-15, wherein the one or more student model layers and the plurality of target devices comprise user-defined control parameters.

17. The one or more non-transitory computer-readable media of any of clauses 11-16, wherein the first candidate architecture has less error between a predicted output and a true output generated using the set of calibration data than any other candidate architecture included in the one or more candidate architectures.

18. The one or more non-transitory computer-readable media of any of clauses 11-17, wherein performing the plurality of fine-tuning operations on the first candidate architecture comprises training the first candidate architecture on a dataset used to train the trained model.

19. The one or more non-transitory computer-readable media of any of clauses 11-18, wherein a learning rate schedule used when training the trained model is implemented when performing the plurality of fine-tuning operations on the first candidate architecture.

20. Some are directed towards a computer system that comprises: one or more memories including instructions; and one or more processors that are coupled to the one or more memories and, when executing the instructions, are configured to perform the steps of: for each model layer included in a trained model, training one or more student model layers to mimic the model layer; for a first target device included in a plurality of target devices, generating one or more candidate architectures based on a constrained optimization problem and the one or more trained student model layers; training the one or more candidate architectures on a set of calibration data; selecting a first candidate architecture included in the one or more candidate architectures that is associated with a least amount of error; and performing a plurality of fine-turning training operations on the first candidate architecture to generate a first trained student model Any and all combinations of any of the claim elements recited in any of the claims and/or any elements described in this application, in any fashion, fall within the contemplated scope of the present invention and protection.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating trained artificial neural networks, the method comprising:
for each model layer included in a trained model, training one or more student model layers to mimic the model layer;
for a first target device included in a plurality of target devices, generating one or more candidate architectures based on a constrained optimization problem and the one or more trained student model layers;
training the one or more candidate architectures on a set of calibration data;
selecting a first candidate architecture included in the one or more candidate architectures that is associated with a least amount of error; and
performing a plurality of fine-turning training operations on the first candidate architecture to generate a first trained student model.

2. The computer-implemented method of claim 1, wherein generating the one or more candidate architectures comprises generating a linear constrained optimization problem based on an objective function included in the constrained optimization problem, and computing a solution to the linear constrained optimization problem to generate at least one of the one to more candidate architectures.

3. The computer-implemented method of claim 2, wherein the linear constrained optimization problem includes a linear function that comprises an approximation of the objective function included in the constrained optimization problem.

4. The computer-implemented method of claim 1, wherein the one or more student model layers and the plurality of target devices comprise user-defined control parameters.

5. The computer-implemented method of claim 1, wherein the first candidate architecture has less error between a predicted output and a true output generated using the set of calibration data than any other candidate architecture included in the one or more candidate architectures.

6. The computer-implemented method of claim 1, wherein performing the plurality of fine-tuning operations on the first candidate architecture comprises training the first candidate architecture on a dataset used to train the trained model.

7. The computer-implemented method of claim 6, wherein a learning rate schedule used when training the trained model is implemented when performing the plurality of fine-tuning operations on the first candidate architecture.

8. The computer-implemented method of claim 1, wherein the one or more student layers include a copy of each layer included in the trained model, a pruned version of each layer included in the trained model, at least one identity layer, at least one attention layer, or at least one multilayer perceptron layer.

9. The computer-implemented method of claim 1, wherein the one or more student model layers and the model layer have the same input dimensions and the same output dimensions.

10. The computer-implemented method of claim 1, wherein the first trained student model has less execution latency relative to an execution latency associated with the trained model.

11. One or more non-transitory computer-readable media including instructions that, when executed by one or more processors, cause the one or more processors to perform the steps of:
for each model layer included in a trained model, training one or more student model layers to mimic the model layer;
for a first target device included in a plurality of target devices, generating one or more candidate architectures based on a constrained optimization problem and the one or more trained student model layers;
training the one or more candidate architectures on a set of calibration data;
selecting a first candidate architecture included in the one or more candidate architectures that is associated with a least amount of error; and
performing a plurality of fine-turning training operations on the first candidate architecture to generate a first trained student model.

12. The one or more non-transitory computer-readable media of claim 11, wherein the plurality of target devices include at least one of a server machine, a desktop machine, a graphics processing unit, a laptop computer, or a mobile phone.

13. The one or more non-transitory computer-readable media of claim 11, wherein the first trained student model has a memory footprint that is smaller than a memory footprint associated with the trained model.

14. The one or more non-transitory computer-readable media of claim 11, wherein generating the one or more candidate architectures comprises generating a linear constrained optimization problem based on an objective function included in the constrained optimization problem, and computing a solution to the linear constrained optimization problem to generate at least one of the one to more candidate architectures.

15. The one or more non-transitory computer-readable media of claim 14, wherein the linear constrained optimization problem includes a linear function that comprises an approximation of the objective function included in the constrained optimization problem.

16. The one or more non-transitory computer-readable media of claim 11, wherein the one or more student model layers and the plurality of target devices comprise user-defined control parameters.

17. The one or more non-transitory computer-readable media of claim 11, wherein the first candidate architecture has less error between a predicted output and a true output generated using the set of calibration data than any other candidate architecture included in the one or more candidate architectures.

18. The one or more non-transitory computer-readable media of claim 11, wherein performing the plurality of fine-tuning operations on the first candidate architecture comprises training the first candidate architecture on a dataset used to train the trained model.

19. The one or more non-transitory computer-readable media of claim 18, wherein a learning rate schedule used when training the trained model is implemented when performing the plurality of fine-tuning operations on the first candidate architecture.

20. A computer system, comprising:
one or more memories including instructions; and
one or more processors that are coupled to the one or more memories and, when executing the instructions, are configured to perform the steps of:
for each model layer included in a trained model, training one or more student model layers to mimic the model layer;
for a first target device included in a plurality of target devices, generating one or more candidate architectures based on a constrained optimization problem and the one or more trained student model layers;
training the one or more candidate architectures on a set of calibration data;
selecting a first candidate architecture included in the one or more candidate architectures that is associated with a least amount of error, and
performing a plurality of fine-turning training operations on the first candidate architecture to generate a first trained student model.
